(19) United States
(12) Patent Application Publication
(10) Pub. No.: US 2005/0227210 A1
(43) Pub. Date: Oct. 13, 2005

(54) Utility tool for communication

(76) Inventor: Laurie Johnson, Austin, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 11/104,106

(22) Filed: Apr. 12, 2005

Related U.S. Application Data
(60) Provisional application No. 60/561,470, filed on Apr. 12, 2004.

(51) Int. Cl. G09B 19/00

(52) U.S. Cl. 434/156

(57) ABSTRACT

A communication tool (101) is provided herein which is suitable for use with non-verbal, speech-impaired or autistic individuals. The tool comprises a display surface (103) which is adapted to be worn by a user, and a plurality of communications cards (105) which are releasably attachable to said display surface. The display surface is transformable from a first configuration wherein the display surface is maintained in a compact orientation on the body of the user, to a second configuration wherein the display surface is maintained in an expanded orientation on the body of the user.

### RELATED APPLICATIONS

This application claims priority to U.S. Ser. No. 60/561,470, filed Apr. 12, 2004, entitled “Utility Tool for Communication,” having the same inventors, and is incorporated herein by reference in its entirety.

### FIELD OF THE INVENTION

The following disclosure pertains generally to communication tools, and more particularly to communication tools that can be used with verbally challenged individuals.

### BACKGROUND OF THE INVENTION

One of the challenges encountered in working with individuals who are non-verbal, speech-impaired, autistic, or otherwise verbally challenged relates to the difficulty that these individuals have in communicating with others and in conveying their basic needs and desires. Several devices and techniques have been developed in the art that are intended to facilitate or improve the communication skills and abilities of these individuals.

U.S. Pat. No. 6,056,549 (Fletcher) discloses a communications tool that is typical of many of the devices known to the art. The tool disclosed therein is a communication and teaching aid for increasing the communication skills of a nonverbal, speech and/or language impaired individual. The device comprises a collection assembly which is preferably in the form of a book structure having a plurality of movably mounted pages, each of which serves as a support structure for a plurality of demonstration pieces. Informative indicia is formed on an exposed surface of each of the demonstration pieces, either in the form of an alpha-numeric display or in the form of a pictorial representation with a word or phrase label, wherein the informative indicia is representative of subject related categories of common objects, activities, statements, phrases, questions, answers, etc. A coding system is utilized to identify each of the plurality of demonstration pieces by category so as to facilitate their accessibility and identity when at least one demonstration piece of a given category is desired to be used either by the individual or by one communicating with or teaching the individual. In use, the impaired individual, or one communicating with or teaching that individual, chooses one or more of the demonstration pieces so as to create an expressive communication. The collected demonstration pieces are then removably attached in a cooperative array on a primary display portion of the collection assembly, wherein the cooperative array defines a question or statement intended by either the individual or the one communicating with that individual.

While the device of Fletcher may be suitable for its intended purpose, book-like tools of the type disclosed therein are inherently bulky. Thus, while such a tool may be portable to a degree, it is insufficiently portable for use in every day life, especially outside of the classroom. Moreover, devices of this type occupy the hands of the user, and thus impede the ability of the user to accomplish other tasks while the tool is in use.

Some communication tools have been developed to date which mitigate some of these infirmities. Thus, for example, some communication tools have been developed which are designed to be worn by the user. An example of such a tool is the device depicted in FIG. 1. This tool 11 comprises an apron 13 which is worn around the waist of a user 15. The apron is equipped with a plurality of communications cards 17, the undersides of which (not shown) are equipped with hook-and-loop type fasteners that releasably attach to the surface of the apron. Some tools of this type are further equipped with pockets for holding the communications cards when they are not in use. These tools are much more portable than the book-type tools described in Fletcher, and do not occupy the hands of the user when they are in use. However, while tools of this type are a notable advance in the art, they have infirmities of their own.

In particular, while apron-type tools of the kind shown in FIG. 1 are quite portable, they are also quite conspicuous, especially when the communications cards are positioned on the surface of the apron. Hence, their use in a public setting draws unwanted attention to the user, and thus makes some verbally challenged individuals feel uncomfortable. Moreover, while it is often advantageous to have communications cards pre-arranged on the surface of the apron to allow a verbally challenged individual to quickly communicate one or more messages, when the communications cards are so arranged, they are susceptible to being dislodged. This is especially so in crowded public settings, where there is a high likelihood of incidental contact. Also, while aprons of this type are reasonably comfortable to wear when the user is standing, they are not as comfortable to wear when the user is sitting, especially when communications cards are attached to the surface of the apron. This is a significant drawback to the use of these devices, since the user must often wear the device for prolonged periods of time.

There is thus a need in the art for a communications tool that is suitable for use by verbally challenged individuals, that is highly portable, and that provides for quick communication between the user and other persons. There is also a need in the art for a communications tool that allows communications cards to be prearranged on its surface for rapid communication, and that is equipped with a means for protecting the cards from incidental contact when they are so arranged. There is further a need in the art for a tool of the type described above that can be comfortably worn by the user in either a sitting or standing position, even when communications cards are arranged on a surface of the tool. These and other needs are met by the devices and methodologies disclosed herein and hereinafter described.

### BRIEF DESCRIPTION OF THE DRAWINGS

For a more complete understanding of the devices and methodologies disclosed herein, and the advantages thereof, reference is now made to the following brief descriptions taken in conjunction with the accompanying drawings, in which like reference numerals indicate like features.

FIG. 1 is an illustration of a prior art communications tool with communications cards mounted thereon;

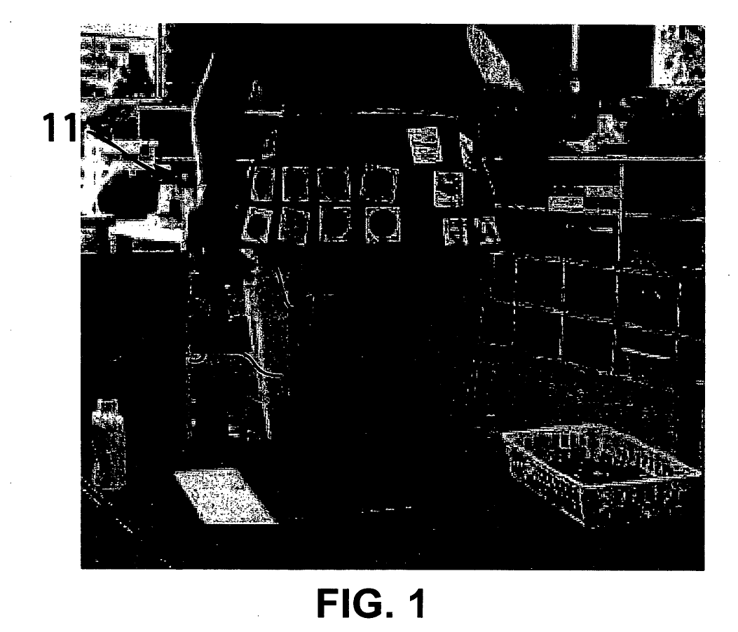

FIG. 2 is a perspective view of a communications tool made in accordance with the teachings herein which has communications cards mounted thereon and which is equipped with a storage pocket (shown in the open position);

FIG. 3 is a perspective view of the communications tool of FIG. 2 with communications cards mounted thereon and with the storage pocket closed;

FIG. 4 is a perspective view of the communications tool of FIG. 2 with the storage pocket closed and with the communications cards removed to show the underlying mount used to attach the cards to the apron; and

FIGS. 5-6 are illustrations of some possible communications cards that may be used in conjunction with the communications tools described herein.

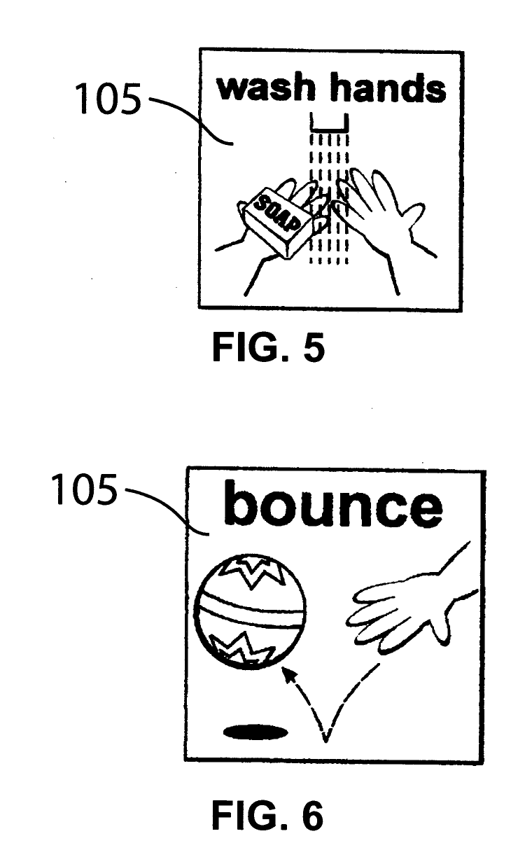

### SUMMARY OF THE INVENTION

In one aspect, a communications tool is provided herein which comprises a display surface adapted to be worn by a user. The display surface is transformable from a first configuration in which the display surface is maintained in a compact orientation on the body of the user, to a second configuration in which the display surface is maintained in an expanded orientation on the body of the user. The tool further comprises a plurality of communications symbols that are releasably attachable to said display surface. In some embodiments, the tool also comprises a pouch which is adapted to hold the communications cards.

Preferably, the display surface is compliant and is folded up or rolled up when it is in the first configuration, and is approximately flat, or adapts itself to the body of the user, when it is in the second configuration. More preferably, the tool is in the form of an apron. The communications symbols are preferably releasably attachable to the display surface, as, for example, through the use of a hook-and-loop type fastener or the like, and the display surface is preferably equipped with one or more straps or belts for attaching the display surface to the body of a user. In some embodiments, the display surface is maintained in the compact orientation by way of a releasable fastener, which may be, for example, a hook-and-loop type fastener or the like.

### DETAILED DESCRIPTION OF THE INVENTION

A highly portable communications tool is disclosed herein that is suitable for use by verbally challenged individuals. The tool comprises a wearable display surface, preferably in the form of an apron, upon which communications cards may be mounted. The display surface is provided with a releasable fastener that allows it to be folded or rolled up into a compact bundle while the tool is being worn, even with communications cards mounted thereon. Hence, the tool can be folded or rolled up after communications cards are arranged on the display surface, thus allowing the user to quickly access the cards while preventing the cards from being dislodged prior to use. Moreover, because the display surface can be folded or rolled up into a compact bundle when it is not in use, it can be discretely worn by a user when the user is in either a sitting or standing position. Other aspects, objectives and advantages of the devices and methodologies disclosed herein will become more apparent from the remainder of the detailed description when taken in conjunction with the accompanying drawings.

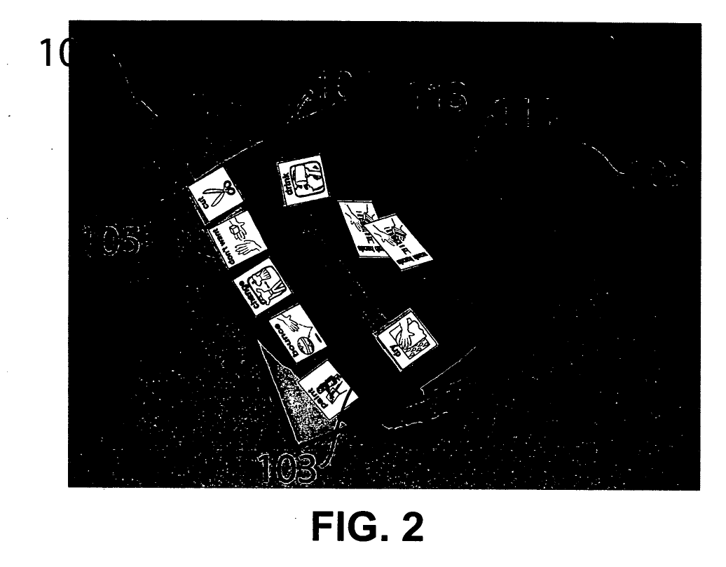

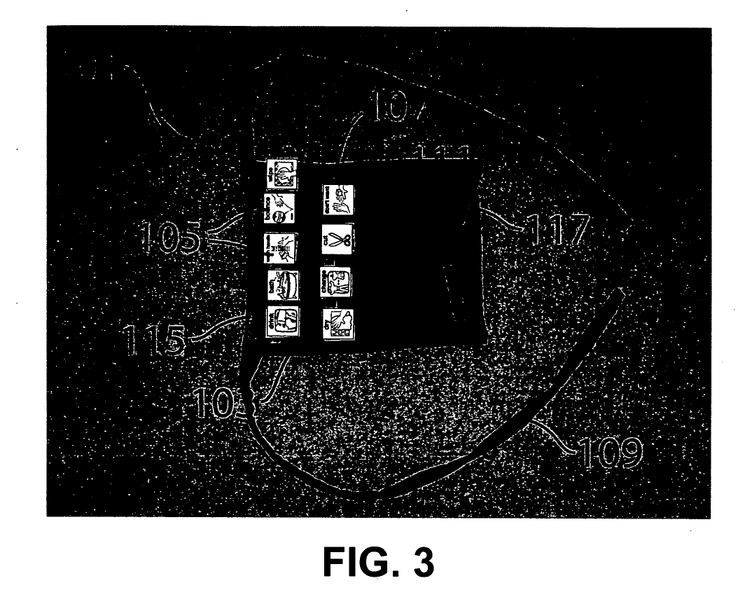

The communications tools disclosed herein may be better understood with reference to FIGS. 2-4, which illustrate one particular, non-limiting embodiment of a communications tool made in accordance with the teachings herein. The communications tool 101 disclosed therein comprises a display surface 103 upon which a plurality of communications cards 105 may be releasably mounted (see FIGS. 2 and 3). In the particular embodiment shown, the communications cards are releasably attached to strips 107 of a hook and loop type fastener or the like which are mounted on the display surface and which are adapted to releasably mate with a similar material (not shown) adhered to the back of the communications cards. Of course, one skilled in the art will appreciate that various other fastening mechanisms may be used for these purposes.

In the particular embodiment depicted, the tool is provided with a series of straps 109 which may be used to attach the tool to the body of a user. Of course, various other attachment means may be used for this purpose, including adjustable belts and bands. Thus, for example, in some embodiments, a waist band may be provided with the tool, and the tool may be adapted to releasably attach to the waist band. For example, the waist band may comprise an elastic material which is equipped with hook and loop type fasteners or the like that releasably mate with similar fasteners disposed on the back of the tool.

The tool is further provided with a pouch 111 which may be used for storage of the communications cards. This pouch may be provided with a releasable fastener 113, such as a hook-and-loop type fastener or the like, so that it may be releasably sealed. The pouch provides for easy access and transportation of communications cards.

The tool illustrated in FIGS. 2-4 is preferably constructed out of a material that is sufficiently rigid to support communications cards thereon, and yet is sufficiently pliant so that it can be rolled or folded into a compact mass. For example, the bulk of the tool may be fabricated out of a double-backed quilted cotton fabric.

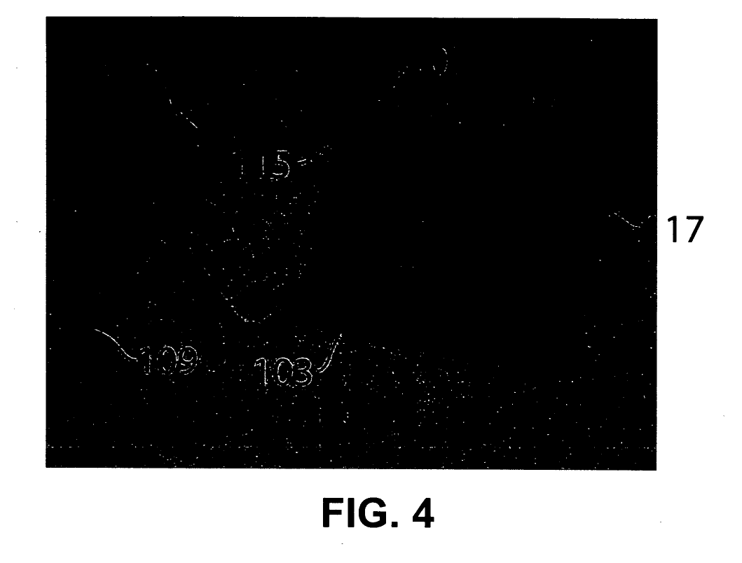

The display surface is preferably equipped with first 115 and second 117 fastening elements (see FIGS. 3 and 4) that are positioned on the display surface such that the display surface can be folded into, and maintained in, a compact configuration. This allows the tool to be inconspicuously worn on the body of the user when it is not in use, much like a money belt or fanny pack. However, the tool may, at any time, be quickly unfolded or unfurled for use.

Through proper placement of the first 115 and second 117 fastening elements and the strips 107 of hook-and-loop type fastener on the display surface, the tool may be configured such that any communications cards mounted on the display surface may be kept there when the tool is folded into a compact configuration. This may be achieved, for example, by insuring that the distance between folds is greater than the height of the cards. Consequently, a number of communications cards may be prearranged on the display surface and left there when the tool is in the compact configuration so that the user will have rapid access to them simply by unfolding the tool.

In one particular embodiment of the tool illustrated in FIGS. 2-4, the tool is approximately 10 inches wide and, when open, about 12 inches long. Of course, one skilled in the art will appreciate that these dimensions may vary considerably and may be tailored to the user or application. The tool may also be provided in a series of predefined sizes.

A communications tool has been disclosed herein that is suitable for use by verbally challenged individuals, that may be worn on the body of the user, and that is transformable from a first, compact configuration to a second, expanded configuration. Since many modifications, variations and changes in detail can be made to the described preferred embodiment of the devices and methodologies disclosed herein, it is intended that all matters in the foregoing description and shown in the accompanying drawings be interpreted as illustrative and not in a limiting sense. Thus, for example, while the device disclosed herein has been described primarily with reference to its use as a communications tool, it may be used in other applications. For example, the tool may be used in fly fishing to hold tackle. Hence, the scope of the invention should be determined by the appended claims and their legal equivalents.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A communication tool, comprising:
a display surface adapted to be worn by a user, said display surface being transformable from a first configuration wherein said display surface is maintained in a compact orientation on the body of the user, to a second configuration wherein said display surface is maintained in an expanded orientation on the body of the user; and
a plurality of communications cards releasably attachable to said display surface.

2. The communication tool of claim 1, wherein said display surface is folded up when it is in said first configuration.

3. The communication tool of claim 1, wherein said display surface is rolled up when it is in said first configuration.

4. The communication tool of claim 1, wherein said display surface is conformable to the body of the user when it is in said second configuration.

5. The communication tool of claim 1, wherein said utility tool is in the form of an apron.

6. The communication tool of claim 1, further comprising a pouch adapted to hold said cards.

7. The communication tool of claim 1, wherein said communications cards are releasably attachable to said display surface by way of a hook and loop type fastener.

8. The communication tool of claim 1, wherein said display surface is equipped with straps for attaching said display surface to the body of a user.

9. The communication tool of claim 1, wherein said display surface is maintained in said compact orientation by way of a releasable fastener.

10. The communication tool of claim 9, wherein said releasable fastener is a hook and loop type fastener.

11. The communication tool of claim 1, wherein said communications cards comprise at least one picture or text disposed on a card.
